(19) United States
(12) Patent Application Publication
(10) Pub. No.: US 2018/0250987 A1
(43) Pub. Date: Sep. 6, 2018

(54) PNEUMATIC TIRE COMPRISING LOW-CARBON CARCASS REINFORCING CORDS AND HAVING REDUCED THICKNESSES OF RUBBER MIXTURES

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Arnaud VERLEENE, Ladoux, Clermont-Ferrand Cedex 9 (FR); Emmanuel JOULIN, Ladoux, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 15/757,211

(22) PCT Filed: Sep. 2, 2016
(86) PCT No.: PCT/EP2016/070704

§ 371 Date: Mar. 2, 2018

(30) Foreign Application Priority Data
Sep. 4, 2015 (FR) 1558203

(51) Int. Cl. B60C 9/00; B60C 9/02; B60C 1/00; D07B 1/06

(52) U.S. Cl. CPC B60C 9/0007; B60C 9/02; B60C 1/0041; D07B 1/0633; B60C 2009/0085; D10B 2101/20; B60C 2009/0092; D07B 2205/305; D07B 2501/2046; D10B 2505/12; B60C 2200/06

(57) ABSTRACT

The tire has a radial carcass reinforcement which includes at least one layer of metal reinforcing elements and a crown reinforcement, which is capped radially with a tread. The metal reinforcing elements of at least one layer of the carcass reinforcement are cords with several steel threads that have a weight content of carbon C such that 0.01%≤C<0.4%. The cords exhibit, in the “permeability” test, a flow rate of less than or equal to 20 cm³/min. The thickness of the rubber compound between the inner surface of the tire cavity and the point of a metal reinforcing element of the carcass reinforcement that is closest to the inner surface of the cavity is less than 3.2 mm, and the steel threads have a maximum tensile strength R, expressed in MPa, such that R≥175+930.0-600.ln(d) and R≥1500 MPa.

### CROSS-REFERENCE TO RELATED APPLICATION

The present application claims priority to PCT International Patent Application Serial No. PCT/EP2016/037255, filed Mar. 9, 2017, entitled “PNEUMATIC TIRE COMPRISING LOW-CARBON CARCASS REINFORCING CORDS AND HAVING REDUCED THICKNESSES OF RUBBER MIXTURES,” which claims the benefit of FR 1558200, filed Sep. 4, 2015, the entire disclosures of the applications being considered part of the disclosure of this application and hereby incorporated by reference.

### BACKGROUND OF THE INVENTION

### 1. Field of the Invention

The present disclosure relates to a tire having a radial carcass reinforcement and more particularly to a tire intended to equip vehicles carrying heavy loads and running at sustained speed, such as, for example, lorries, tractors, trailers or buses.

### 2. Related Art

In general, in tires for heavy-duty vehicles, the carcass reinforcement is anchored on each side in the bead region and is surmounted radially'by a crown reinforcement consisting of at least two superposed layers formed of threads or cords which are parallel within each layer and crossed from one layer to the next, making angles of between 10° and 45° with the circumferential direction. The working layers that form the working reinforcement may furthermore be covered with at least one layer, referred to as a protective layer, formed of reinforcing elements which are advantageously metal and extensible and are referred to as elastic reinforcing elements. It may also comprise a layer of metal threads or cords having low extensibility, forming an angle of between 45° and 90° with the circumferential direction, this ply, referred to as the triangulation ply, being located radially between the carcass reinforcement and the first crown ply, referred to as the working ply, which are formed of parallel threads or cords lying at angles not exceeding 45° in terms of absolute value. The triangulation ply forms a triangulated reinforcement with at least the working ply, this reinforcement having little deformation under the various stresses to which it is subjected, the triangulation ply essentially serving to absorb the transverse compressive forces which is the role of all the reinforcing elements in the crown area of the tire.

In the case of tires for “heavy-duty” vehicles, just one protective layer is usually present and its protective elements are, in the majority of cases, oriented in the same direction and with the same angle in terms of absolute value as those of the reinforcing elements of the radially outermost and thus radially adjacent working layer. In the case of construction plant tires intended for running on more or less uneven ground, the presence of two protective layers is advantageous, the reinforcing elements being crossed from one layer to the next and the reinforcing elements of the radially inner protective layer being crossed with the inextensible reinforcing elements of the radially outer working layer adjacent to the radially inner protective layer.

The circumferential direction of the tire, or longitudinal direction, is the direction corresponding to the periphery of the tire and defined by the direction in which the tire runs.

The transverse or axial direction of the tire is parallel to the axis of rotation of the tire.

The radial direction is a direction which intersects the axis of rotation of the tire and is perpendicular thereto.

The axis of rotation of the tire is the axis about which it turns in normal use.

A radial or meridian plane is a plane which contains the axis of rotation of the tire.

The circumferential median plane, or equatorial plane, is a plane perpendicular to the axis of rotation of the tire and which divides the tire into two halves.

Certain present-day tires, referred to as “road tires”, are intended to run at high speed and over increasingly long journeys, because of improvements to the road network and the growth of motorway networks worldwide. The combination of conditions under which such a tire has to run undoubtedly allows an increase in the distance covered since tire wear is lower; however, the endurance of the tire is detrimentally affected. In order to allow one, indeed even two, retreadings of such tires in order to lengthen their life, it is necessary to retain a structure and in particular a carcass reinforcement the endurance properties of which are sufficient to withstand the retreadings.

Prolonged running under particularly severe conditions of the tires thus constructed effectively results in limits appearing regarding the endurance of these tires.

The elements of the carcass reinforcement are in particular subjected to bending and compressive stresses during running which adversely affect their endurance. Specifically, the cords which form the reinforcing elements of the carcass layers are subjected to high stresses during the running of the tires, in particular to repeated bending actions or variations in curvature, resulting in rubbing actions at the threads and thus in wear, and also in fatigue; this phenomenon is described as “fatigue fretting”.

In order to perform their role of strengthening the carcass reinforcement of the tire, the cords first of all have to exhibit good flexibility and a high flexural endurance, which implies in particular that their threads exhibit a relatively small diameter, preferably of less than 0.28 mm, more preferentially of less than 0.25 mm, generally smaller than that of the threads used in conventional cords for crown reinforcements of tires.

The cords of the carcass reinforcement are also subject to “fatigue-corrosion” phenomena due to the very nature of the cords, which favor the passage of and, indeed even drain, corrosive agents, such as oxygen and moisture. This is because the air or the water which penetrates into the tire, for example when damaged by a cut or more simply as the result of the permeability albeit low, of the interior surface of the tire, can be conveyed by the channels formed within the cords by the very fact of their structure.

All these fatigue phenomena, which are generally grouped together under the generic term of “fatigue-fretting-corrosion”, cause a progressive deterioration in the mechanical properties of the cords and can, for the most severe running conditions, affect the life of the cords.

In order to improve the endurance of these cords of the carcass reinforcement, it is known in particular to increase the thickness of the layer of rubber which forms the internal wall of the tire cavity in order to limit as much as possible the permeability of the layer. This layer is usually partly composed of butyl, so as to increase the airtightness of the tire. This type of material exhibits the disadvantage of increasing the cost of the tire.

It is also known to modify the construction of the cords in order in particular to increase their penetrability by the rubber and thus limit the dimension of the passage for oxidizing agents.

It is further known, to limit the dimension of the passage for oxidizing agents, to produce cords containing layers, the inner layers of which are sheathed with a layer of elastomers during their manufacture, such that the migration of oxidizing agents is made virtually impossible along the reinforcing elements of the carcass reinforcement. Such cords are for example described in the patent EP-B-1699973.

### SUMMARY OF THE INVENTION AND ADVANTAGES

The inventors have been able to demonstrate that, while these solutions are favorable to the reinforcing elements to combat phenomena of “fatigue-fretting-corrosion”, it turns out that, during running under particularly severe conditions in terms of load or pressure, the reinforcing elements of the carcass reinforcement oxidize prematurely in a very local manner.

The inventors thus set themselves the task of providing tires for heavy vehicles of “heavy-duty” type, the endurance performance of the reinforcing elements of the carcass reinforcement of which remains satisfactory, in particular from the viewpoint of the “fatigue corrosion” or “fatigue-fretting-corrosion” phenomena, regardless of the running conditions, and for which the manufacturing cost remains acceptable.

This aim was achieved according to the disclosure by a tire having a radial carcass reinforcement, consisting of at least one layer of metal reinforcing elements, the tire comprising a crown reinforcement, itself capped radially with a tread, the tread being joined to two beads via two sidewalls, the metal reinforcing elements of at least one layer of the carcass reinforcement being cords consisting of several steel threads having a weight content of carbon C such that 0.01%≤C<0.4%, the cords of at least one layer of the carcass reinforcement exhibiting, in the “permeability” test, a flow rate of less than or equal to 20 cm³/min, the thickness of the rubber compound between the inner surface of the tire cavity and the point of a metal reinforcing element of the carcass reinforcement that is closest to the inner surface of the cavity being less than or equal to 3.2 mm and the steel threads having a maximum tensile strength R, expressed in MPa, such that R≥175+930.C−600.ln(d) and R≥1500 MPa, d being the diameter of the steel threads.

The “permeability” test makes it possible to determine the longitudinal permeability to air of the cords tested, by measuring the volume of air passing along a test specimen under constant pressure over a given period of time. The principle of such a test, which is well known to a person skilled in the art, is to demonstrate the effectiveness of the treatment of a cord to make it impermeable to air; it has been described for example in standard ASTM D2692-98.

The test is carried out on cords extracted directly, by stripping, from the vulcanized rubber plies which they reinforce, thus penetrated by the cured rubber.

The test is carried out on a 2 cm length of cord, which is therefore coated with its surrounding rubber composition (or coating rubber) in the cured state, in the following way: air is sent to the inlet of the cord, under a pressure of 1 bar, and the volume of air at the outlet is measured using a flow meter (calibrated, for example, from 0 to 500 cm³/min). During the measurement, the sample of cord is immobilized in a compressed airtight seal (for example, a seal made of dense foam or of rubber) so that only the amount of air passing along the cord from one end to the other, along its longitudinal axis, is taken into account by the measurement; the airtightness of the airtight seal itself is checked beforehand using a solid rubber test specimen, that is to say one devoid of cord.

The lower the mean air flow rate measured (mean over 10 test specimens), the higher the longitudinal impermeability of the cord. As the measurement is carried out with an accuracy of ±0.2 cm³/min, measured values less than or equal to 0.2 cm³/min are regarded as zero; they correspond to a cord which can be described as airtight (completely airtight) along its axis (i.e. in its longitudinal direction).

This permeability test also constitutes a simple means of indirect measurement of the degree of penetration of the cord by a rubber composition. The lower the flow rate measured, the greater the degree of penetration of the cord by the rubber.

Cords exhibiting, in the “permeability” test, a flow rate of less than 20 cm³/min have a degree of penetration higher than 66%.

The degree of penetration of a cord can also be estimated according to the method described below. In the case of a layered cord, the method consists, in a first step, in removing the outer layer from a sample with a length of between 2 and 4 cm in order to subsequently measure, in a longitudinal direction and along a given axis, the sum of the lengths of rubber compound in relation to the length of the sample. These measurements of lengths of rubber compound exclude the spaces not penetrated along this longitudinal axis. These measurements are repeated along three longitudinal axes distributed over the periphery of the sample and are repeated on five samples of cord.

When the cord comprises several layers, the first step of removal is repeated with what is now the outer layer and the measurements of lengths of rubber compound along longitudinal axes.

A mean of all the ratios of lengths of rubber compound to lengths of samples thus determined is then calculated in order to define the degree of penetration of the cord.

The thickness of the rubber compound between the inner surface of the tire cavity and the point of a reinforcing element that is closest to the surface is equal to the length of the orthogonal projection of the end of the point of a reinforcing element that is closest to the surface onto the inner surface of the tire cavity.

The measurements of the thickness of rubber compound are carried out on a cross section of a tire, the tire thus being in a non-inflated state.

The maximum tensile strength or ultimate tensile strength corresponds to the force necessary to break the thread. The measurements of maximum tensile strength, denoted by R (in MPa), are carried out according to the ISO 6892 standard of 1984.

According to a preferred embodiment of the disclosure, the rubber compound between the tire cavity and the reinforcing elements of the radially innermost carcass reinforcement layer consisting of at least two layers of rubber compound, the radially innermost layer of rubber compound has a thickness less than or equal to 1.5 mm. As explained above, this layer is usually partially composed of butyl so as to increase the airtightness of the tire, and since this type of material has a not inconsiderable cost, the reduction of this layer is positive.

Further preferably according to the disclosure, the layer of rubber compound radially adjacent to the radially innermost layer of rubber compound has a thickness less than or equal to 1.7 mm. The thickness of this layer, the constituents of which in particular make it possible to fix oxygen from the air, may also be reduced so as to further reduce the cost of the tire.

The thicknesses of each of these two layers are equal to the length of the orthogonal projection of a point of a surface onto the other surface of the layer.

The inventors have been able to demonstrate that a tire thus produced according to the disclosure results in highly advantageous improvements in terms of the compromise between endurance and manufacturing costs. Indeed, the endurance properties with such a tire are improved compared to the solutions mentioned above, especially under particularly severe running conditions. Moreover, since the thickness of the layer of rubber compound between the carcass reinforcement and the tire cavity is reduced in comparison with conventional tires and because this layer is one of the most expensive components of the tire, the cost of manufacturing the tire is lower than that of a conventional tire. The cords of the carcass reinforcement, consisting of several steel threads having a weight content of carbon C such that 0.01%≤C<0.4%, make it possible to limit the risks of local oxidation of the reinforcers of the carcass reinforcement which could appear under particularly severe running conditions.

Indeed, the inventors have been able to demonstrate that the solutions of the type of heavily penetrated cords, or cords comprising an elastomeric mixture deposited during the manufacture of the cord at the inner layers, lead to a non-uniform distribution of the air pressure within the compounds; indeed, over a meridian section, the distribution of pressure at the carcass reinforcement varies along the latter. The inventors believe that this non-uniformity can be interpreted as being due to the non-circulation of air within the cords and therefore solely due to the presence of air linked to the passage through the compounds. The residual pressure at the carcass must therefore depend essentially on the thicknesses of compound to be passed through from the cavity, and on the reactivity of the compounds to oxygen. Since these thicknesses may vary along the carcass along a meridian section, either due to the very design of the tire or due to deformations of the compounds during the manufacture and in particular during the shaping of the tire, they may explain these variations in pressure. The zones subjected to higher pressures may then lead to oxidation and hence premature ageing of the reinforcing elements of the carcass reinforcement. The choice of cords of the carcass reinforcement consisting of several steel threads having a weight content of carbon C such that 0.01%≤C<0.4% makes it possible to further limit this type of risk of local oxidation.

Moreover, the maximum tensile strength values of the threads according to the disclosure further promotes performance in terms of endurance of the tire, the mechanical properties of the carcass reinforcement being thereby assured to withstand attacks of the impact type which may appear in use on the sidewalls or else on the tread.

Indeed, since the weight content of carbon C is relatively low, the drawability of the thread is improved, that is to say the possibility of work-hardening the thread sufficiently by drawing to confer upon it significant mechanical strength properties and in particular a satisfactory maximum tensile strength. It may thus be possible to reduce the diameter of the thread, and thus to lighten the tire, while retaining sufficient mechanical strength to reinforce the tire.

In addition, even though the maximum tensile strength may in certain cases be lower than that of threads of the prior art having a higher weight content of carbon C, the thread according to the disclosure is much less sensitive to fatigue and to corrosion, which improves the endurance of the tire and compensates for any initial deficit it may have in maximum tensile strength.

Further preferably according to the disclosure, the steel threads have a weight content of chromium Cr such that Cr<12%.

The use of a low content of chromium Cr makes it possible to obtain a thread having advantages in terms of constraints linked to the environment. Indeed, the use of chromium requires employing specific, expensive measures, in particular during the recycling of such threads, which may be avoided by virtue of the thread according to the disclosure.

Advantageously according to the disclosure, the microstructure of the steel is completely ferritic, pearlitic or a mixture of these microstructures.

Thus, the microstructure of the steel is free of martensite and/or bainite. A ferritic-martensitic microstructure leads to cleavage between the ferritic and martensitic phases which is undesirable. A martensitic microstructure is not ductile enough to allow drawing of the thread, which would break too frequently.

A ferritic, pearlitic or ferritic-pearlitic microstructure is distinguished from another microstructure, in particular martensitic or bainitic microstructure, by metallographic observation. The ferritic-pearlitic microstructure has ferrite grains and also lamellar pearlitic zones. On the contrary, the martensitic microstructure comprises laths and/or needles that those skilled in the art will know how to distinguish from the grains and lamellae of the ferritic-pearlitic and pearlitic microstructures.

More preferentially according to the disclosure, the microstructure of the steel is completely ferritic-pearlitic.

The threads according to the disclosure are made of steel, that is to say that they consist predominantly (that is to say for more than 50% by weight) or completely (for 100% by weight) of steel as defined in the standard NF EN10020. In accordance with this standard, a steel is a material containing more iron than any other element, that has a carbon content of less than 2% and that contains other alloying elements. Still in accordance with this standard, the steel optionally comprises other alloying elements.

Preferably, the steel is an unalloyed steel as defined in the standard NF EN10020. Thus, the steel comprises, in addition to carbon and iron, other known alloying elements in amounts in accordance with the standard NF EN10020.

In another embodiment, the steel is an alloy steel as defined in the standard NF EN10020. In this embodiment, the steel comprises, in addition to the carbon and iron, other known alloying elements.

Preferably, the steel is not a stainless steel as defined in the standard NF EN10020. Thus, in this embodiment, the steel preferentially comprises at most 10.5% by weight of chromium.

Advantageously, the thread has a weight content of carbon C such that 0.07%≤C ≤0.3%, preferably 0.1%≤C≤0.3%, and more preferably 0.15%≤C≤0.25%.

Advantageously, R>350+930.0−600.ln(d), preferably R>500+930.C−600.ln(d), more preferentially R>700+930.C−600.ln(d).

Advantageously, d is greater than or equal to 0.10 mm and preferably greater than or equal to 0.12 mm.

When the diameter d is too small, the industrial production cost of the thread becomes too high and incompatible with mass production.

In some embodiments, d>0.15 mm and R≥1800 MPa and preferably d>0.15 mm and R≥1900 MPa.

Advantageously, d is less than or equal to 0.40 mm, preferably less than or equal to 0.25 mm, more preferentially less than or equal to 0.23 mm and even more preferentially less than or equal to 0.20 mm.

When the diameter d is too large, the flexibility and endurance of the thread are too low for a use of the thread in certain plies of the tire, in particular the carcass reinforcement, for example for a vehicle of the heavy-duty vehicle type.

In some embodiments, d<0.15 mm and R>2000 MPa and preferably d<0.15 mm and R>2100 MPa.

According to one embodiment of the disclosure, the metal reinforcing elements of at least one layer of the carcass reinforcement are layered metal cords of [L+M] or [L+M+N] construction of use as reinforcing element in a tire carcass reinforcement, comprising a first layer C1 of L threads of diameter d₁, with L ranging from 1 to 4, surrounded by at least one intermediate layer C2 of M threads of diameter d₂ wound together in a helix at a pitch p₂, with M ranging from 3 to 12, the layer C2 possibly being surrounded by an outer layer C3 of N threads of diameter d₃ wound together in a helix at a pitch p₃, with N ranging from 8 to 20.

Preferably, the diameter of the threads of the first layer of the inner layer (C1) is between 0.10 and 0.4 mm and the diameter of the threads of the outer layers (C2, C3) is between 0.10 and 0.4 mm.

Further preferably, the helical pitch at which the threads of the outer layer (C3) are wound is between 8 and 25 mm.

Within the meaning of the disclosure, the pitch represents the length, measured parallel to the axis of the cord, at the end of which a thread having this pitch makes one complete turn around the axis of the cord; thus, if the axis is sectioned by two planes perpendicular to the axis and separated by a length equal to the pitch of a thread of a constituent layer of the cord, the axis of this thread has, in both these planes, the same position on the two circles corresponding to the layer of the thread under consideration.

In the L+M+N construction according to the disclosure, the intermediate layer C2 preferably comprises six or seven threads, and the cord in accordance with the disclosure then has the following preferential features (d₁, d₂, d₃, p₂ and p₃ in mm):
(i) 0.10<d₁<0.28;
(ii) 0.10<d₂<0.25;
(iii) 0.10<d₃<0.25;
(iv) M=6 or M=7;
(v) 5π(d₁d₂)<p₂≤p₃<5π(d₁+2d₂+d₃);
(iv) the threads of the layers C2, C3 are wound in the same direction of twisting (S/S or Z/Z).

Preferably, feature (v) is such that p₂=p₃, such that the cord is the to be compact, bearing in mind also feature (vi) (threads of layers C2 and C3 wound in the same direction).

According to feature (vi), all the threads of the layers C2 and C3 are wound in the same direction of twisting, that is to say either in the S direction (“S/S” arrangement) or in the Z direction (“Z/Z” arrangement). Winding the layers C2 and C3 in the same direction advantageously makes it possible, in the cord in accordance with the disclosure, to minimize rubbing between these two layers C2 and C3 and thus the wearing of the threads of which they are made (since there is no longer cross contact between the threads).

Preferably, the cord of the disclosure is a layered cord with a construction referred to as 1+M+N, that is to say that its internal layer Cl is made up of a single thread.

The threads of the layers C2 and C3 may have diameters that are identical or different from one layer to the other. Use is preferably made of threads of the same diameter (d2=d3), in particular in order to simplify the cabling method and keep costs down.

The disclosure is preferably implemented with a cord chosen from cords of structure 1+9, 1+4+8, 1+4+9, 1+4+10, 1+5+9, 1+5+10, 1+5+11, 1+6+10, 1+6+11, 1+6+12, 1+7+11, 1+7+12 or 1+7+13.

According to a preferred embodiment of the disclosure, the cords of the carcass reinforcement exhibit, in the“permeability” test, a flow rate of less than 10 cm³/min and more preferably still of less than 2 cm³/min.

According to an advantageous embodiment of the disclosure, the metal reinforcing elements of at least one layer of the carcass reinforcement are cords having at least two layers, at least one inner layer being sheathed with a layer consisting of a non-crosslinkable, crosslinkable or crosslinked rubber composition, preferably based on at least one diene elastomer.

The expression “composition based on at least one diene elastomer” is interpreted, in a known way, as meaning that the composition comprises a majority content (i.e. a weight fraction of more than 50%) of this or these diene elastomers.

It will be noted that the sheath according to the disclosure extends continuously around the layer that it covers (that is to say that this sheath is continuous in the“orthoradial” direction of the cord which is perpendicular to its radius), so as to form a continuous sleeve having a cross section which is advantageously practically circular.

It will also be noted that the rubber composition of this sheath is crosslinkable or crosslinked; that is to say that it comprises, by definition, a crosslinking system adapted to allow the composition to be crosslinked during the curing thereof (i.e. the hardening thereof, and not the melting thereof); thus, this rubber composition may be described as unmeltable because it cannot be melted by heating, regardless of the temperature.

The term“diene” elastomer or rubber denotes, in a known way, an elastomer which results at least in part (i.e. a homopolymer or a copolymer) from diene monomers (monomers bearing two carbon-carbon double bonds, which may or may not be conjugated).

Diene elastomers can be classified in a known way into two categories: those to be “essentially unsaturated” and those said to be“essentially saturated”.“Essentially unsaturated” diene elastomer is generally intended here to mean a diene elastomer resulting at least in part from conjugated diene monomers having a content of units of diene origin (conjugated dienes) which is greater than 15% (mol %). Thus, for example, diene elastomers such as butyl rubbers or copolymers of dienes and of α-olefins of EPDM type do not fall within the above definition and can in particular be described as“essentially saturated” diene elastomers (low or very low content of units of diene origin, always less than 15%). In the category of“essentially unsaturated” diene elastomers,“highly unsaturated” diene elastomer is understood in particular to mean a diene elastomer having a content of units of diene origin (conjugated dienes) which is greater than 50%.

Given these definitions, diene elastomer capable of being used in the cord of the disclosure is understood more particularly to mean:
(a) any homopolymer obtained by polymerization of a conjugated diene monomer having from 4 to 12 carbon atoms;
(b) any copolymer obtained by copolymerization of one or more conjugated dienes with one another or with one or more vinylaromatic compounds having from 8 to 20 carbon atoms;
(c) a ternary copolymer obtained by copolymerization of ethylene and an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d) a copolymer of isobutene and of isoprene (butyl rubber) and also the halogenated versions, in particular chlorinated or brominated versions, of this type of copolymer.

Although it applies to any type of diene elastomer, the present disclosure is first and foremost employed with essentially unsaturated diene elastomers, in particular of the above type (a) or (b).

Thus, the diene elastomer is preferentially selected from the group consisting of polybutadienes (BRs), natural rubber (NR), synthetic polyisoprenes (IRs), the different butadiene copolymers, the different isoprene copolymers and mixtures of these elastomers. Such copolymers are more preferentially selected from the group consisting of butadiene/stirene copolymers (SBRs), isoprene/butadiene copolymers (BIRs), isoprene/stirene copolymers (SIRs) and isoprene/butadiene/stirene copolymers (SBIRs).

Further preferably according to the disclosure, the diene elastomer chosen consists predominantly (that is to say for more than 50 phr) of an isoprene elastomer. “Isoprene elastomer” is understood to mean, in a known way, an isoprene homopolymer or copolymer, in other words a diene elastomer selected from the group consisting of natural rubber (NR), synthetic polyisoprenes (IRs), various isoprene copolymers and the mixtures of these elastomers.

According to an advantageous mode of the disclosure, the diene elastomer chosen consists exclusively (that is to say for 100 phr) of natural rubber, of synthetic polyisoprene or of a mixture of these elastomers, the synthetic polyisoprene having a content (mol%) of cis-1,4-bonds preferably of greater than 90%, more preferentially still greater than 98%.

According to a particular embodiment of the disclosure, it is also possible to use blends (mixtures) of this natural rubber and/or these synthetic polyisoprenes with other highly unsaturated diene elastomers, in particular with SBR or BR elastomers as mentioned above.

The rubber sheath of the cord of the disclosure may contain a single, or several, diene elastomer(s), the latter possibly being used in combination with any type of synthetic elastomer other than diene elastomer, or even with polymers other than elastomers, for example thermoplastic polymers, these polymers other than elastomers then being present as minor polymer.

Although the rubber composition of the sheath is preferentially devoid of any plastomer and it only comprises a diene elastomer (or mixture of diene elastomers) as polymer base, the composition could also comprise at least one plastomer in a weight fraction xₚ less than the weight fraction xₑ of the elastomer(s). In such a case, the following relation preferably applies: 0<xₚ<0.5. xₑ, and more preferentially: 0<xₚ<0.1. xₑ.

Preferably, the system for crosslinking the rubber sheath is a“vulcanization” system, that is to say a system based on sulfur (or on a sulfur-donating agent) and on a primary vulcanization accelerator. Various known secondary vulcanization accelerators or vulcanization activators may be added to this basic vulcanization system. Sulfur is used at a preferential content of between 0.5 and 10 phr, more preferentially of between 1 and 8 phr, and the primary vulcanization accelerator, for example a sulfenamide, is used at a preferential content of between 0.5 and 10 phr, more preferentially of between 0.5 and 5.0 phr.

The rubber composition of the sheath according to the disclosure comprises, in addition to the crosslinking system, all the customary ingredients that can be used in rubber compositions for tires, such as reinforcing fillers based on carbon black and/or on a reinforcing inorganic filler such as silica, anti-ageing agents, for example antioxidants, extending oils, plasticizers or agents that improve the workability of the compositions in the raw state, methylene acceptors and donors, resins, bismaleimides, known adhesion-promoting systems of the “RFS” (resorcinol-formaldehyde-silica) type or metal salts, in particular cobalt salts.

Preferably, the composition of the rubber sheath has, in the c osslinked state, a secant tensile modulus, at 10% elongation (denoted M10), measured according to standard ASTM D 412 of 1998, of less than 20 MPa and more preferentially less than 12 MPa, in particular between 4 and 11 MPa.

Preferentially, the composition of this sheath is chosen to be identical to the composition used for the rubber matrix which the cords according to the disclosure are intended to reinforce. Thus, there is no problem of possible incompatibility between the respective materials of the sheath and of the rubber matrix.

Preferably, the composition is based on natural rubber and it comprises carbon black as reinforcing filler, for example a carbon black of grade (ASTM) 300, 600 or 700 (for example N326, N330, N347, N375, N683, N772).

According to a variant embodiment of the disclosure, the crown reinforcement of the tire is formed of at least two working crown layers of preferably inextensible reinforcing elements, crossed from one layer to the other, forming, with the circumferential direction, angles of between 10° and 45°.

According to other variant embodiments of the disclosure, the crown reinforcement further comprises at least one layer of circumferential reinforcing elements.

A preferred embodiment of the disclosure further provides for the crown reinforcement to be supplemented on its radially outer side by at least one additional layer, called the protective layer, of what are called elastic reinforcing elements, oriented with respect to the circumferential direction at an angle of between 10° and 45° and in the same direction as the angle formed by the inextensible elements of the working layer which is radially adjacent thereto.

The protective layer may have an axial width which is less than the axial width of the narrowest working layer. The protective layer may also have an axial width greater than the axial width of the narrowest working layer, such that it overlaps the edges of the narrowest working layer and, when it is the layer radially above which is narrowest, such that it is coupled, in the axial extension of the additional reinforcement, with the widest working crown layer over an axial width in order thereafter, axially on the outside, to be decoupled from the widest working layer by profiled elements having a thickness at least equal to 2 mm. The protective layer formed of elastic reinforcing elements can, in the abovementioned case, on the one hand be optionally decoupled from the edges of the narrowest working layer by profiled elements having a thickness substantially less than the thickness of the profiled elements separating the edges of the two working layers and, on the other hand, have an axial width less than or greater than the axial width of the widest crown layer.

According to any one of the embodiments of the disclosure mentioned hereinabove, the crown reinforcement may further be supplemented, radially on the inside between the carcass reinforcement and the radially internal working layer closest to the carcass reinforcement, by a triangulation layer of inextensible metal reinforcing elements made of steel forming with the circumferential direction an angle greater than 60° and in the same direction as the direction of the angle formed by the reinforcing elements of the radially closest layer of the carcass reinforcement.

### BRIEF DESCRIPTION OF THE DRAWINGS

Further details and advantageous features of the disclosure will become apparent from the following description of exemplary embodiments of the invention, with reference to FIGS. 1 to 2, which depict:

FIG. 1: a meridian view of a diagram of a tire according to an embodiment of the disclosure,

FIG. 2: an enlarged partial view of a part of the diagram of FIG. 1.

In order to make them easier to understand, the figures have not been drawn to scale.

### DETAILED DESCRIPTION OF THE ENABLING EMBODIMENT

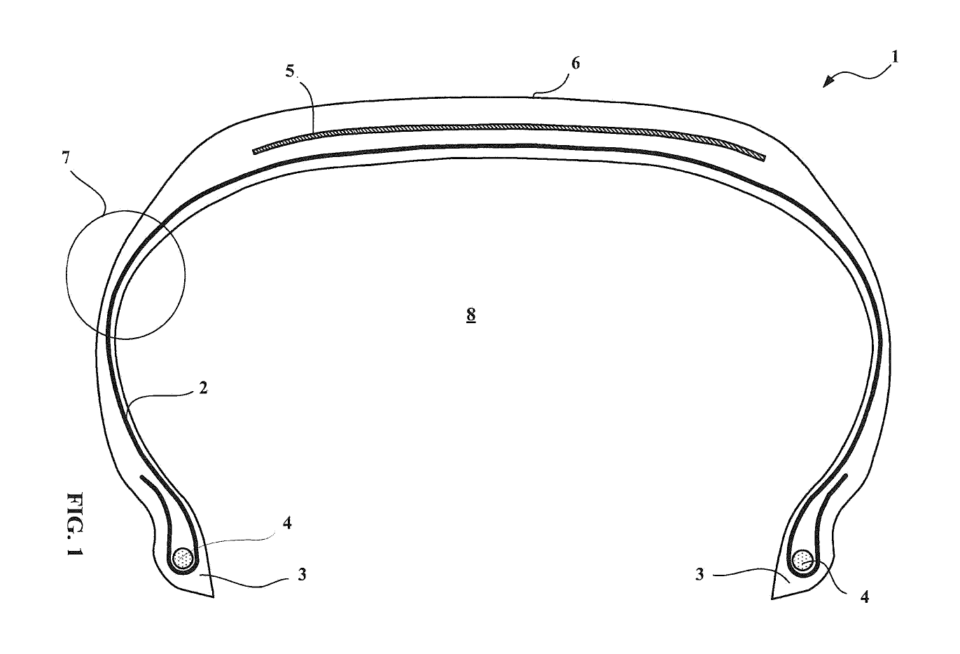

In FIG. 1, the tire 1, of size 295/80 R 22.5, comprises a radial carcass reinforcement 2 anchored in two beads 3 around bead wires 4. The carcass reinforcement 2 is formed of a single layer of metal cords 11 and of two calendering layers 13. The carcass reinforcement 2 is wrapped by a crown reinforcement 5, itself capped by a tread 6. The crown reinforcement 5 is formed radially, from the inside towards the outside:
of a triangulation layer formed of non-wrapped 9.28 inextensible metal cords, oriented at an angle equal to 65°,
of a first working layer formed of non-wrapped inextensible 11.35 metal cords which are continuous across the entire width of the ply, oriented at an angle equal to 26°,
of a second working layer formed of non-wrapped 11.35 inextensible metal cords, which are continuous over the entire width of the ply, oriented at an angle equal to 18°, and crossed with the metal cords of the first working layer,
of a protective layer formed of non-wrapped elastic 6.35 metal cords which are continuous across the entire width of the ply, oriented at an angle equal to 18° in the same direction as the metal cords of the second working layer.

The combination of these layers, constituting the crown reinforcement 5, is not depicted in detail in the figures.

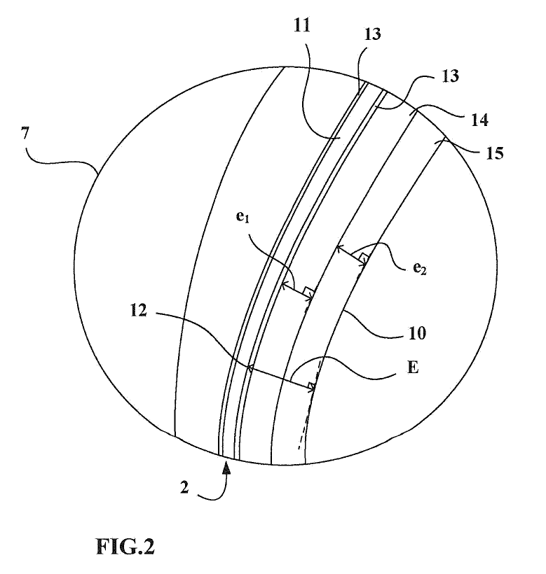

FIG. 2 illustrates an enlargement of region 7 in FIG. 1 and in particular indicates the thickness E of rubber compound between the inner surface 10 of the tire cavity 8 and the point 12 of a reinforcing element 11 that is closest to the surface 10. This thickness E is equal to the length of the orthogonal projection of the point 12 of a reinforcing element 11 that is closest to the surface 10 onto the surface 10. This thickness E is the sum of the thicknesses of the various rubber compounds placed between the reinforcing element 11 of the carcass reinforcement 2; it corresponds, on the one hand, to the thickness of the calendering layer 13 radially on the inside of the carcass reinforcement and, on the other hand, to the thicknesses e₁, e₂ of the various layers 14, 15 of rubber compound that form the internal wall of the tire 1. These thicknesses e₁, e₂ are moreover equal to the length of the orthogonal projection of a point on one surface onto the other surface of the respective layer 14 or 15 concerned.

These thickness measurements are carried out on a cross section of the tire, the latter consequently not being fitted or inflated.

The value of E measured is equal to 2.4 mm.

The values of e₁ and e₂ are respectively equal to 1.4 mm and 1 mm.

The cords of the carcass reinforcement of the tire 1 are non-wrapped layered cords of 1+6+12 structure, consisting of a central nucleus formed of a thread, of an intermediate layer formed of six threads and of an outer layer formed of twelve threads.

They exhibit the following characteristics (d and p in mm):
1+6+12 structure;
d₁=0.20 (mm);
d₂=0.18 (mm);
p₂=10 (mm);
d₃=0.18 (mm);
p₂=10 (mm);
(d₂/d₃)/1;
   with d₂ and p₂ respectively the diameter and the helical pitch of the intermediate layer and d₃ and p₃ respectively the diameter and the helical pitch of the threads of the outer layer.

The steel threads constituting the cords of the carcass reinforcement have a weight content of carbon C equal to 0.21%.

The maximum tensile strength of the steel threads constituting the cords of the carcass reinforcement is equal to 2750 MPa.

The core of the cords, composed of the central nucleus formed of a thread and of the intermediate layer formed of the six threads is sheathed with a rubber composition based on unvulcanized diene elastomer (in the raw state). The sheathing is obtained via a head for extrusion of the core composed of the central nucleus formed of a thread surrounded by the six threads of the intermediate layer. Subsequently, a final operation in which the 12 threads of the outer layer are twisted or cabled around the core thus sheathed makes it possible to finish the cords.

The aptitude for penetration of the cords of the carcass reinforcement thus produced, measured according to the method described above, is equal to 95%.

Tests have been carried out on tires P produced according to the disclosure in accordance with the depiction in FIGS. 1 and 2, and other tests have been carried out with what are referred to as reference tires R.

These reference tires R differ from the tires P according to the disclosure by cords of the carcass reinforcement comprising a sheathing layer around the inner layers but the steel threads of which, constituting the cords of the carcass reinforcement, have a weight content of carbon C equal to 0.58% and a maximum tensile strength equal to 2830 MPa.

Endurance testing with running on an external roller with a circumference equal to 8.5 meters was carried out, with the tires being subjected to a load of 4176 daN and a speed of 40 km/h, with oxygen-doped inflation of the tires to 10.2 bar. These tests were carried out in a temperature-controlled chamber at 15° C. The tests were carried out for the tires according to the disclosure under conditions identical to those applied to the reference tires. The running operations are halted as soon as the tires exhibit carcass reinforcement degradation.

The distance travelled is measured until the tire exhibits a degradation. The measurements illustrated below are referenced to a base 100 for the reference tire.

| | R | P |
|---|---|---|
| km | 100 | 125 |

These results show that, under particularly severe running conditions, the tires according to the disclosure have better performance in terms of endurance than the reference tires. The faults in the latter are due to localized oxidation of the cords of the carcass reinforcement. Such faults only appear in the tires according to the disclosure at higher distances.

1. A tire having a radial carcass reinforcement, consisting of at least one layer of metal reinforcing elements, said tire comprising a crown reinforcement, itself capped radially with a tread, said tread being joined to two beads via two sidewalls, wherein the metal reinforcing elements of at least one layer of the carcass reinforcement are cords consisting of several steel threads having a weight content of carbon C such that 0.01%≤C <0.4%, wherein said cords of at least one layer of the carcass reinforcement exhibit, in the “permeability” test, a flow rate of less than or equal to 20 cm³/min, wherein the thickness of the rubber compound between the inner surface of the tire cavity and the point of a metal reinforcing element of the carcass reinforcement that is closest to said inner surface of the cavity is less than or equal to 3.2 mm and wherein said steel threads have a maximum tensile strength R, expressed in MPa, such that R≥175+930.C−600.ln(d) and R≥1500 MPa, d being the diameter of said steel threads.

2. The tire according to claim 1, the rubber compound between the tire cavity and the reinforcing elements of the radially innermost carcass reinforcement layer consisting of at least two layers of rubber compound, wherein the radially innermost layer of rubber compound has a thickness less than or equal to 1.5 mm.

3. The tire according to one of claims 1 and 2, the rubber compound between the tire cavity and the reinforcing elements of the radially innermost carcass reinforcement layer consisting of at least two layers of rubber compound, wherein the layer of rubber compound radially adjacent to the radially innermost layer of rubber compound has a thickness less than or equal to 1.7 mm.

4. The tire according to one of the preceding claims, wherein said steel threads have a weight content of chromium Cr such that Cr<12%.

5. The tire according to one of the preceding claims, wherein the metal reinforcing elements of at least one layer of the carcass reinforcement are layered metal cords of [L+M] or [L+M+N] construction of use as reinforcing element in a tire carcass reinforcement, comprising a first layer C1 of L threads of diameter d₁, with L ranging from 1 to 4, surrounded by at least one intermediate layer C2 of M threads of diameter d₂ wound together in a helix at a pitch p₂, with M ranging from 3 to 12, said layer C2 possibly being surrounded by an outer layer C3 of N threads of diameter d₃ wound together in a helix at a pitch p₃, with N ranging from 8 to 20.

6. The tire according to claim 5, wherein the diameter of the threads of the first layer (C1) is between 0.10 and 0.4 mm, and wherein the diameter of the threads of the layers (C2, C3) is between 0.10 and 0.4 mm.

7. The tire according to one of the preceding claims, wherein said cords of at least one layer of the carcass reinforcement exhibit, in the “permeability” test, a flow rate of less than 10 cm³/min and preferably of less than 2 cm³/min.

8. The tire according to one of the preceding claims, wherein said cords of at least one layer of the carcass reinforcement are cords having at least two layers and wherein at least one inner layer is sheathed with a layer consisting of a rubber composition which is non-crosslinkable, crosslinkable or crosslinked, preferably based on at least one diene elastomer.

9. The tire according to one of the preceding claims, wherein the crown reinforcement is formed of at least two working crown layers of reinforcing elements that are crossed from one layer to the other and form, with the circumferential direction, angles of between 10° and 45°.

10. The tire according to one of the preceding claims, wherein the crown reinforcement further comprises at least one layer of circumferential reinforcing elements.

11. The tire according to one of the preceding claims, wherein the crown reinforcement is supplemented radially on the outside by at least one additional ply, referred to as a protective ply, of reinforcing elements, referred to as elastic reinforcing elements, that are oriented with respect to the circumferential direction at an angle of between 10° and 45° and in the same direction as the angle formed by the inextensible elements of the working ply which is radially adjacent thereto.

12. The tire according to one of the preceding claims, wherein the crown reinforcement also comprises a triangulation layer formed of metal reinforcing elements that form angles of more than 60° with the circumferential direction.
